(19) United States
(12) Patent Application Publication
(10) Pub. No.: US 2002/0071580 A1
(43) Pub. Date: Jun. 13, 2002

(54) Line array speakers rigging system

(76) Inventors: Mark Engebretson, Encino, CA (US); Yoshiyuki Takeuchi, Pine Mountain Club, CA (US)

Correspondence Address: Squire, Sanders & Dempsey, L.L.P., 14th Floor, 801 S. Figueroa Street, Los Angeles, CA, 90017-5554, US

(21) Appl. No.: 09/921,095

(22) Filed: Jul. 31, 2001

Related U.S. Application Data
(60) Provisional application No. 60/300,372, filed on Jun. 22, 2001.
(60) Provisional application No. 60/222,026, filed on Jul. 31, 2000.

(51) Int. Cl. H04R 25/00; H04R 1/02

(52) U.S. Cl. 381/182; 381/186; 381/386

(57) ABSTRACT

This invention provides a system enabling the assembly and suspension of a plurality of line array loudspeakers where the splay angle between the adjacent speakers can be easily adjusted and rigidly maintained. This line array system utilizes rigging frames allowing for the coupling and supporting of the loudspeakers forming and rigidly maintaining a curvature in the line speaker array.

### CROSS-REFERENCES TO RELATED APPLICATIONS

This application is a non-provisional application claiming priority on two U.S. provisional applications, Ser. Nos. 60/300,372 filed Jun. 22, 2001, and 60/222,026 filed Jul. 31, 2000.

### BACKGROUND OF THE INVENTION

1. Field of the Invention

This invention relates to a rigging system for line array speakers. Specifically, this invention relates to a system of assembling and suspending a plurality of line array speakers and adjusting the splay angle between the speakers in order to control and produce the desired sound radiation.

2. Description of the Related Art

In the realm of loudspeaker sound systems, a line-source array is a group of similarly sized sound radiating sources that provide increased directivity at various frequencies. Line arrays can offer significant advantages over traditional multi-box sound systems. For example, it provides an extension of the near-field coverage area because the distance from the near field to far field transition zone is increased with frequency. This phenomenon of observable near-field extension through the use of line arrays has been presented in prior art literature and is well known in the art.

Another advantage of a line array system is that one can arrange the speakers at a specific angle and height to optimize the sound level output and achieve the desired coverage. The height of an array governs its directivity and the spacing of the individual elements is a second-order effect that determines the lobing structure of the line array. By properly arranging the line array speakers and articulating or curving the line array in the vertical plane at a specific angle, one can provide excellent coverage for listeners seated in both the near and the far fields.

To reproduce the desired sound level and wider coverage in large buildings such as a big auditorium or a concert hall, etc., it is known that a plurality of accurately arranged loudspeakers may be mounted on the specially designed racks with other hanging equipment. Yet, there are notable disadvantages with the known multi-speaker based sound reproducing systems. Many venue situations typically have more than one seating plane, and it is important to determine the optimum line array configuration and arrange such configuration accordingly. With the conventional systems, it has been difficult, for example, to adjust and maintain the splay angle between adjacent speakers. In addition, the angles between the line array speakers determine the overall curvature of the line array system, and it is important to maintain the overall integrity of the line array once suspended in the air. Depending on the particular seating plane, the speakers must be deployed precisely and maintained in a specific vertical angle in order not to cause phase interference between the sounds from the adjacent loudspeakers. The conventional systems are not truly ‘rigid’ in that the specific angles between the speakers cannot be maintained constant while the system is suspended or otherwise manipulated.

Another problem associated with the systems known in the art is the difficulty of assembling, suspending and adjusting a plurality of loudspeakers in the desired configuration. Substantial elaborate preparation and labor are required to assemble and install the multiple loudspeakers in a large building such as an auditorium, concert hall or baseball park, etc. The installation time and cost become significant, especially in large-scale operations in which up to several tens of line arrays are to be installed.

Another disadvantage of the conventional systems relates to the transportation of the line array systems from one location to another. The dimensions of the line array system play a significant role in determining the number of transportation vehicles needed, and consequently it has a significant impact on the transportation and operation costs. Many conventional sound systems, for example, utilize a loudspeaker with associated frames that is more than 48 inches wide and therefore make it impossible to vertically double stack the line array speakers with frames in an industry standard U-Haul type truck having about a 96-inch vertical cargo height. Most systems known in the art are designed without the dimensional considerations that are often critical in actual practice of loading and transporting the systems.

Therefore, there is a need for line array speakers that are easy to assemble, suspend and transport. In addition, a need exists for a line array system that provides the ability to adjust and maintain the splay angle between the adjacent speakers and rigidly maintain the curvature of the line array system.

### SUMMARY

This invention provides a system for assembling and suspending a plurality of line array loudspeakers that the splay angle between the adjacent speakers allowing for easy adjustment and maintenance. The line array system utilizes rigging frames to both couple and support loudspeakers. It is these rigging frames and associated connecting hinge bars that together form and rigidly maintain the line array curvature.

The front faces of the adjacent line array speakers are pivotally coupled together at a hinge point and remain juxtaposed with respect to one another while the splay angle is determined by adjusting the distance between the rear faces of the adjacent speakers. The line array system as a whole may be articulated based on the splay angles between the speakers. That is, the line array system may be adjustable to create the desired curvature to provide smooth, even sound coverage to both near and far seating areas.

Each of the line array systems may have a left and right frame coupled to a housing. Each housing of the line array system may include low frequency drivers, mid frequency drivers and high frequency compression drivers.

The frames on each housing may be coupled together by front and rear hinges, and the line array may be either suspended in the air or stacked on the ground using one or more line array frames. Dollies and wheels may be coupled to each speaker for easy moving and assembly of the line array system.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a perspective view depicting various deployments of line array systems.

FIG. 2 is a perspective view of a hanging line array speaker system.

FIG. 3 is a perspective front view of a line array speaker.

FIG. 4 is a perspective view of the rigging frame and front and rear hinge bars.

FIG. 5 is a side view of a rear hinge bar inserted between adjacent rigging frames.

FIG. 6 is a front view of a line array speaker.

FIG. 7 is a front view of the line array speaker housing.

FIG. 8 is a top view of the speaker housing.

FIG. 9 is a cross sectional view of the speaker housing of FIG. 8 along the line 99.

FIG. 10 is a rear sectional view of a typical transportation truck system loaded with the line array systems.

FIG. 11 is a perspective view of a line array speaker with attached rigging frames.

FIG. 12 is a perspective view of the line array system being assembled and lifted.

FIG. 13 is a perspective view depicting the connection of two adjacent line array speaker units.

FIG. 14 is an enlarged view of the portion in FIG. 7 showing the rear hinge bar coupling the rear sides of the adjacent rigging frames.

### DETAILED DESCRIPTION

A line array is a group, often of similarly sized, sound radiating sources that provide increased directivity at various frequencies. The directivity is determined by the height of an array while the spacing of the individual elements is a second-order effect which determines the lobing structure of the line array. Using a simple equation, one can determine the anticipated performance of differently-sized sound radiators and their spacing in relation to each other. To be useful in large-scale sound reinforcement settings, well-designed coverage for listeners seated in both the near and the far fields are important. For the far field coverage, a relatively straight array may radiate the sound level desired. But the near field coverage often requires some degree of curvature to provide uniformity of coverage over a wider vertical angle.

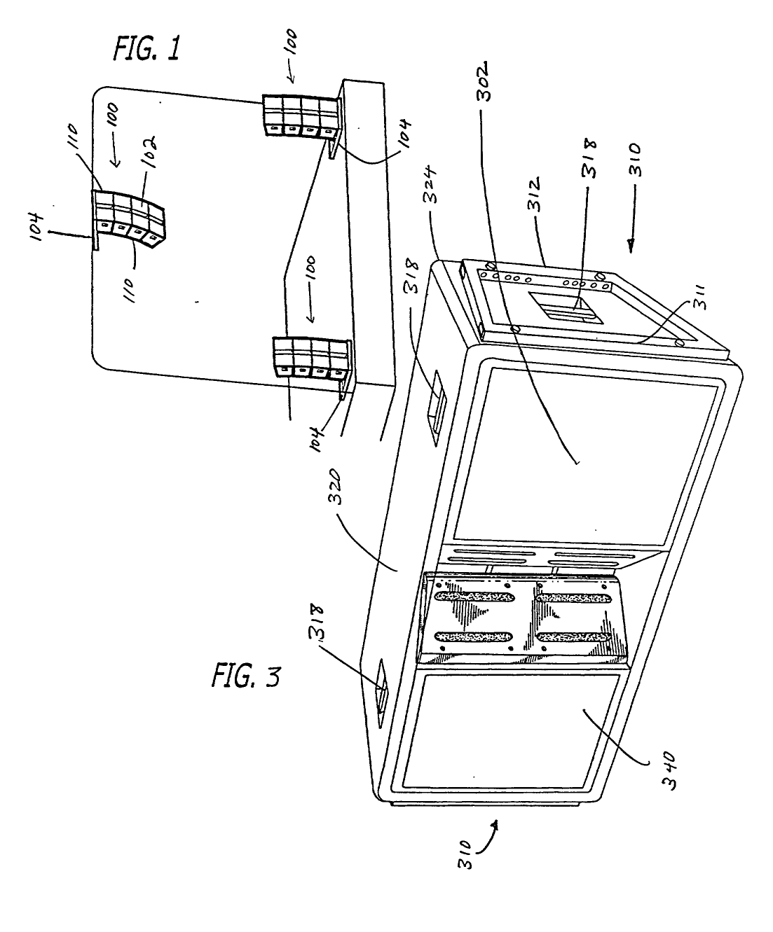

FIG. 1 illustrates each line array speaker 102 having a left and right rigging frames 110 that allows the line array system 100 to be either suspended in the air or ground stacked. To do so, the line array system 100 includes an array frame 104 used to hoist the line array system 100 in the air or used as a base support when ground stacked. Both the air-suspended and the ground stacked systems may be articulated or curved to achieve the optimum sound radiation to a predetermined area.

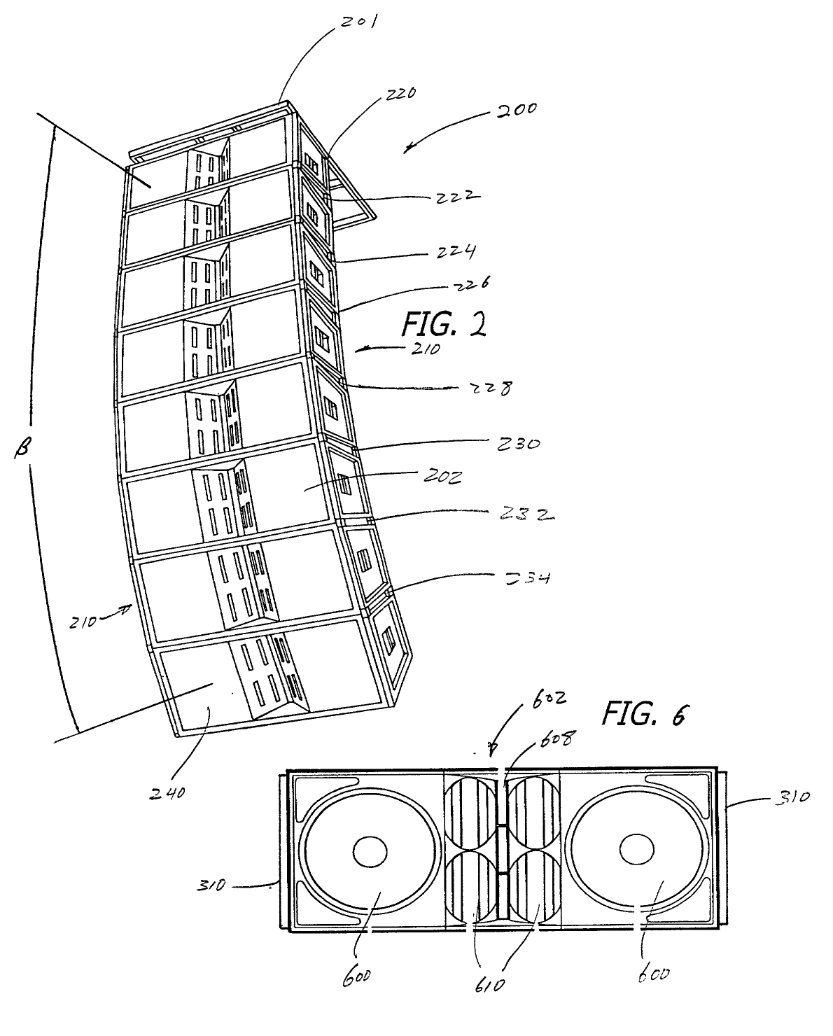

FIG. 2 is a perspective view of a hanging line array speaker system and illustrates the rigging frames 210 on the left and right sides of the array speakers 202 used to successively couple the array speakers 202 together. The array speaker system has a predetermined curvature β providing uniformity of coverage over a wider vertical angle. The curvature β is a summation of all box splay angles on the backside of adjacent array speakers 202. For instance, if the first box splay angle 220 between the first array speaker and array frame 201 is set at 0°, and each of the corresponding box splay angels 222, 224, 226, 228, 2230, 232, and 234 are set at 2°, 2°, 2°, 4°, 4°, 4°, and 6°, respectively, then the curvature φ is 24°. Note that the front surface 240 of the line array system 200 is continuous. For example, the front sides of adjacent array speakers 202 are substantially flush against each other and there is little gap if any between the two on the front side.

A typical line array may have only one array frame 201. However, a second array frame may be utilized to couple to both the top (or first) and the bottom (or the last) line array speaker and suspend the line array from both array frames. This may create an increased directivity of the line array. Using one or two array frames, the line arrays may be manipulated to suspend pointing straight down or suspend at a very wide vertical angle.

In FIG. 3, each speaker 302 has a left and right rigging frame 310 coupled on each side of the speaker. Each rigging frame 310 has a front side 311 and a rear side 312, and is substantially trapezoidal in shape. Alternatively, the rigging frame 310 may have other shapes as well, such as triangular, rectangular, etc. To form the trapezoidal shape, the front side 311 is longer than the rear side 312. Likewise, the speaker housing 320 on the left and right sides form a trapezoidal shape as well such that the front surface 340 of the speaker housing 320 is taller than the back surface 324. To assist in handling the speaker 302, the speaker housing 320 may have handles 318.

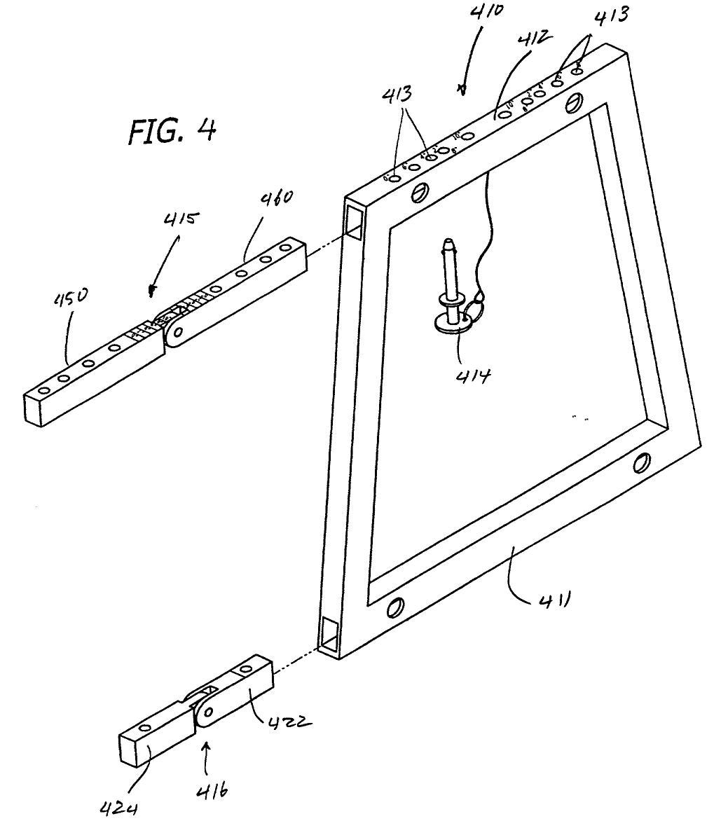

FIG. 4 illustrates in more detail a rigging frame 410 having a front side 411 adapted to slidably receive a front hinge bar 416, and a rear side 412 adapted to slidably receive a rear hinge bar 415. The front hinge bar 416 is smaller than the rear hinge bar 415, and is designed to pivotally couple two adjacent front sides 411 about a pivot point 420. A first arm 422 of the front hinge bar 416 may be inserted into the front side 411 and releasably locked in place, and a second arm 424 may be inserted into the front side 411 of an adjacent rigging frame 410 and releaseably locked in place as well. Again, the two adjacent front sides 411 are coupled so that the front surfaces 440 of two adjacent speakers 402 are substantially flush with respect to each other. The front hinge bars 416 may be captive in the adjacent front sides 411, with a small thumb, or slider knob (not shown) threaded in place after the front hinge bar is fitted into the rigging frame. Moreover, the front hinge bar 416 may be locked with a release pin (not shown) into the rigging frame for storage as well so that it does not get lost.

The rear hinge bar 415 has two arms 450 and 460, which are both marked by degrees, from 0 to 10 in 2-degree increments. The rear hinge-bar design allows changing the angular relationship or the box splay angle between the adjacent line array speakers 302 from 0-degrees to 10-degrees, for example. Moreover, the rear side 412 of the rigging frame 410 has a plurality of holes 413, each hole marked with a specific numeric angle.

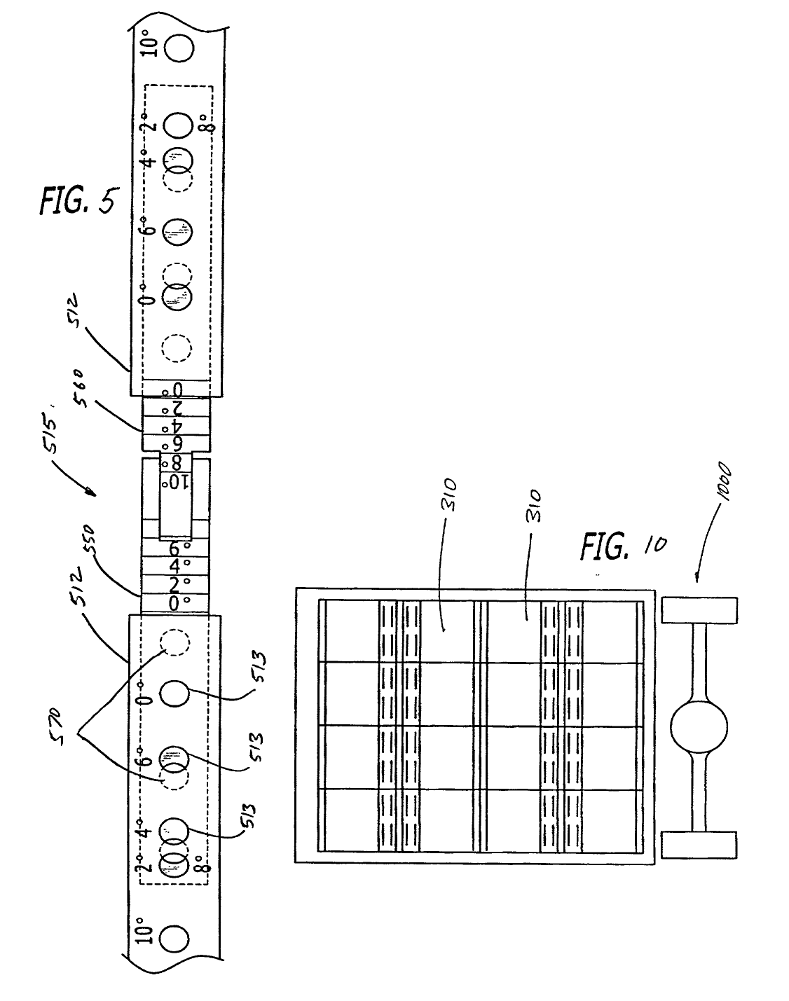

In FIG. 5, each of the two arms 550, 560, of the rear hinge bar 515 may be adapted to be inserted and secured into two adjacent rear sides 512. Beside the markings, the two arms 550, 560 have a plurality of bores 570 through which a release pin 414 (See FIG. 4) may be inserted through to lock the rear hinge bar to the rear side 412 of the rigging frame. With the above marking, the box splay angle may be set at 2-degrees or 1-degree increments.

For instance, to set the box splay angle at 4-degrees, each of the arms 550 and 560 may be inserted into its respective rear side 512 until the 4-degree marking shows on the both arms 550 and 560. At this position, the 4-degree hole 513 on the rear side 512 aligns with one of the bores 570 in the arm so that a pin may be inserted through the hole and the bore to couple the arm to the rear side 512. To set the box splay angle at 1-degree, one arm is inserted into the rear side 512 until 2-degree marking shows and the other arm is inserted into the rear side 512 until 0-degree shows. Again, the front and the rear hinge bars may be stored inside of the rigging frames, so there is no need to carry loose hardware pieces in assorted sizes as with some other modular systems.

FIG. 6 is a front view of the line array speaker 602. The speaker integrates the unique acoustical elements into a highly portable and rugged physical package. In one embodiment, the speaker 602 may weigh less than 72 kg while containing two 600-watt low frequency drivers 600, each having a diameter of about 15 inches. Four 300-watt mid-frequency drivers 610, each having a diameter of about 8 inches may also be included, as well as three vertically stacked 75-watt, 3-inch diaphragm high frequency compression drivers each exiting through a throat opening 608 having a width of about ¾″ to about 1¼″. Each (low/mid/high) frequency driver section may be positioned on the enclosure to align with identical sections of adjacent housings with minimum separation between adjacent housing driver sections so as to form a continuous ‘line’ of like driver components.

In FIGS. 7-8, the nine speakers (two 15-inch low frequency drivers 600, four 8-inch mid-frequency drivers 610, and three high frequency drivers 620) are incorporated into a speaker housing 720 that has a width “w” that is less than about 46 inches. To do so, the speaker housing 720 has a transition line 700 formed at about distance “a” from a center line 702. In this example, if the angle φ between two adjacent side walls incorporating the mid-range drivers 610 is about 90° (see FIG. 8), then the distance “a” between the center line 702 and the transition line 700 may be about 6.21 inches. Moreover, the distance “b” between the center line 702 and the focal point 704 for the opening 706 adapted to receive the low frequency driver 600, may be about 14.29 inches. The opening 706 may have an outer diameter “D” of about 15.34 inches to receive a 15-inch low frequency driver 620. And for this example, the width “t” of the throat opening 708 may be about 1.13 inches.

In FIG. 9, if the angle φ in FIG. 8 is about 90°, then the width “c” of the side wall 710 adapted to receive the two mid-range frequency drivers 610 may be about 7.98 inches, and the inner diameter “d” for the opening 712 adapted to receive an 8-inch mid-range driver 610 may be about 7.25 inches. With the above exemplary dimensions, width “w” for the speaker housing 720 may be about 45.75 inches. And with the width of the rigging frame 310 (see FIG. 6) being about 1.0 inch on each side, the total width of the array speaker 302 (see FIG. 3) is less than about 48.0 inches. Depending on the angle φ between the two adjacent side walls 710, however, the total width “w” may be less. That is, it is within the scope of the invention to have the width “w” be less than 45.75, if the angle φ is less than 90°.

The above width dimension of the array speaker 302 may be designed to improve the ease of transporting the line array speakers with the rigging frames. In the line array industry, it may be desirable to vertically double stack the line array speaker units (speaker plus rigging frames coupled) in an industry standard transport type truck with about 96-inch vertical cargo height. As illustrated in FIG. 10, with the line array system having a width of less than about 48 inches, it is possible to achieve the double stack the line array speakers 310 in a truck 1000 having about a 96-inch vertical cargo height, thereby reducing the number of transportation trucks needed to ship the line array speakers 310.

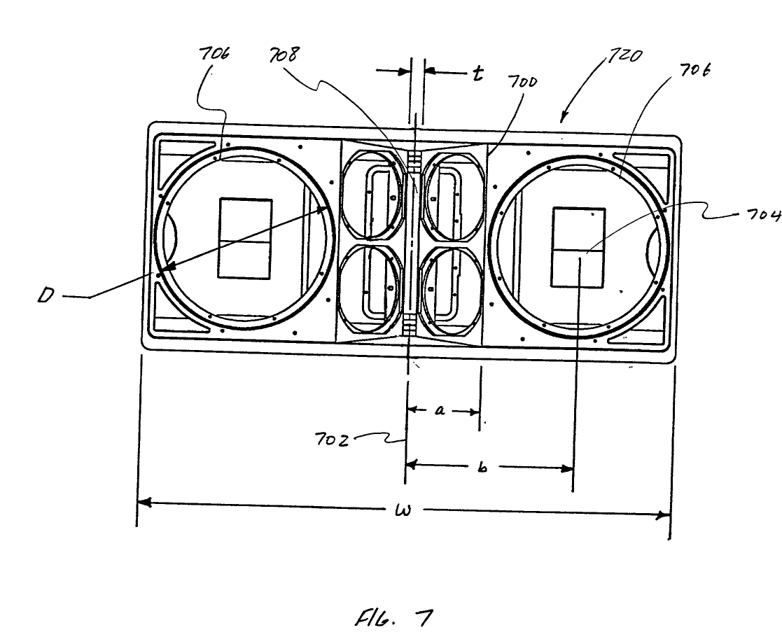

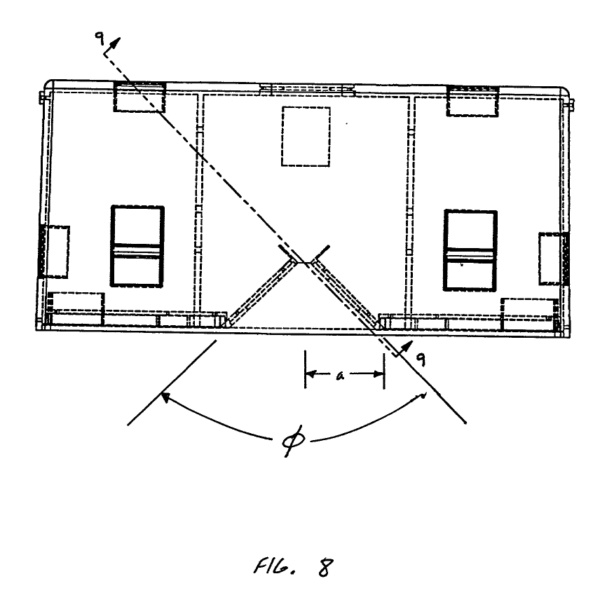

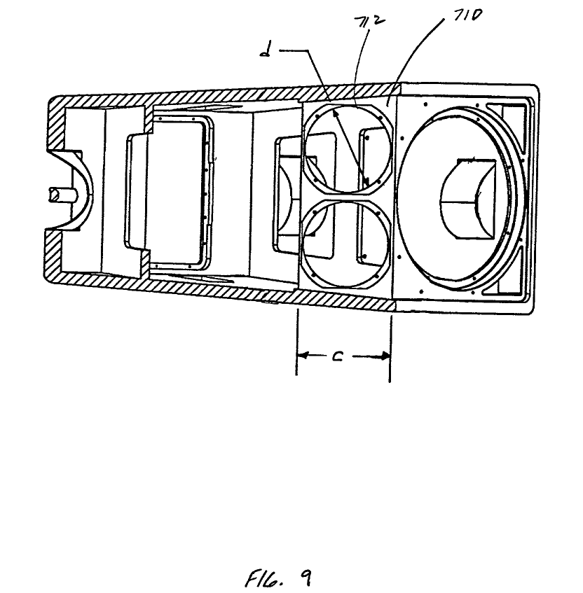

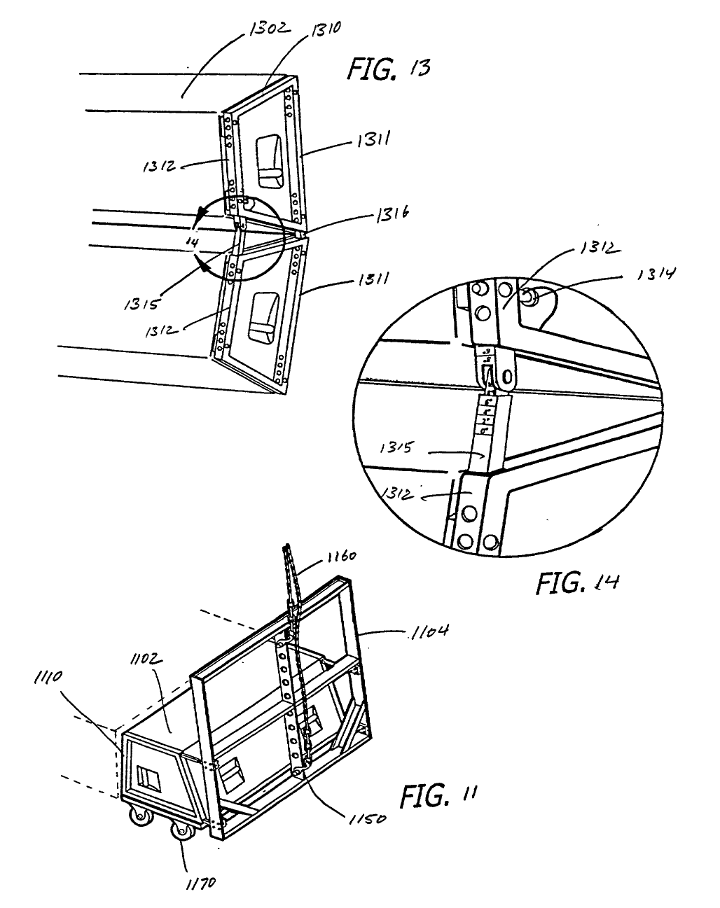

FIGS. 11 through 14 illustrate by way of example how the line array speakers 1102 with the rigging frames 1110 are moved and assembled together in order to be suspended in the air. As seen in FIG. 11, each line array speaker 1102 is provided with left and right rigging frames 1110 and a dolly having wheels 1170 attached at the bottom. The array frame 1104 is positioned at a desired location and one or more shackles 1150 are pinned in the selected holes of the array frame. The shackles are attached to suspension cables 1160 and one or more chain motors (not shown) are used to ultimately raise the array frame. If only one chain motor is used, one should select a hole in the array frame that allows the array frame to be balanced taking into account the center of gravity of the line array system. This varies with the number of boxes and system configuration. A typical suspension or hang uses two chain motors.

The top or the first line array speaker unit is attached to the array frame 1104. One way is to first suspend the array frame, then attach the first (top) speaker unit by rolling the speaker up to the array frame 1104. The attachment is accomplished by connecting the rear hinge bars to the rear receiver blocks (not shown) on the array frame 1104. Using this method, the rear hinge bars will be connected first. The first speaker unit should be set so that its baffle angle is 90 degrees in relationship to the array frame. This puts it in a zero-degree position. Next, the front hinge bars on the first speaker unit are attached to the front receiver blocks (not shown) of the array frame.

Next, the line array frame may be lifted using the chain motor prepared to lift the first speaker unit off the floor. It helps to have the remaining boxes in line here. The additional speaker unit now may be moved into line and the front hinge bars on the unit may be linked first. While pulling the array up slightly, the rear hinge bars on the additional speaker unit may be pinned at a predetermined distance or splay angle by sliding the releasing pin into the desired angle bores on the rear hinge bar and the matching hole on the rear side of the rigging frame.

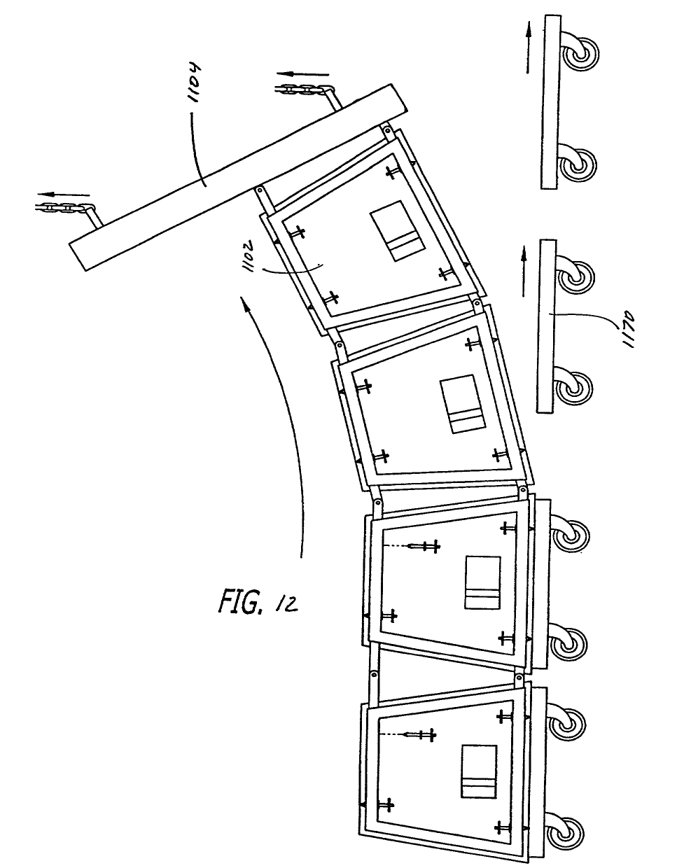

In particular, as illustrated in FIGS. 13 and 14, the rear hinge bars may be utilized to adjust the splay angle between two adjacent line array speakers 1302. The front hinge bar 1316 may be first slidably disposed in the front side of the rigging frame and then pivotally couples to the front side of the adjacent rigging frame. Once coupled, the front sides 1311 of the two adjacent rigging frames remain juxtaposed without a substantial gap. There is no adjustment of the front hinge bar 1316 in that the front hinge bar is designed to be disposed at one fixed position within the front sides of the rigging frame. In addition, once coupled together by the front hinge bar, the front sides of the rigging frames remain at the coupled position while the line array is assembled, suspended, ground-stacked or otherwise manipulated. FIG. 14 is an enlarged view of an encircled area in FIG. 13 showing how the rear hinge bar 1315 connects the adjacent rear sides 1312 of the rigging frames 1310, and shows how each arm of the rear hinge bar 1315 is inserted into the adjacent rear sides 1312. In FIG. 14, the splay angle between the adjacent rigging frames is adjusted by inserting the release pin 1314 at a desired angle position.

Again, by adjusting the predetermined distance between the adjacent rear sides 1312 of the adjacent rigging frames 1310, the splay angle of the speakers and the curvature of the line array system is established. The rear hinge bar 1316 has two arms to be inserted and fixed in each of the adjacent rear sides 1312, and each arm of the rear hinge bar 1315 is marked in two-degree increments as shown in FIG. 5. However, the splay angle may be set at one-degree increments by choosing settings that bracket the desired angle. For example, to set a 5-degree box splay angle, one arm of the rear hinge bar may be pinned at six degrees and the other arm may be set at four degrees. The rear hinge bar 1315 couples the rear sides of the adjacent rigging frames by first inserting the rear hinge bar 1315 to the desired angle or distance, making sure that the bore on the rear hinge bar and the hole on the rear side of the rigging frame match the desired angle and finally inserting the release lock pin 1314. When setting the splay angle, it is important to set the same angle on both the left and right sides of the same line array speakers.

With above method, additional line array speaker units may be added as the array moves up by repeating the process of first pinning the front hinge bars and then the rear hinge bars. As the array is lifted slightly, all the fittings should be checked to ensure that the release pins are in place and secure, the hinge bars are set at the desired angle and the hinge bars are set the same on both sides of each line array speaker. Also, as the array begins to go up, the dollies on the line array speaker unit may be removed. The dolly is typically equipped with quick release latch and side handles (not shown).

There are many other ways to assemble the line array speaker units. For example, the rear hinge bars may be connected first between the adjacent speaker units before connecting the front hinge bars. With each line array speaker unit equipped with a dolly and rigging frames capable of being connected to each other by simply sliding and inserting a releasing pin, unloading the entire assembly and suspending a line array system of up to eighteen speaker units can be accomplished by two trained personnel within 10-20 minutes. This is a significant improvement since the conventional systems known in the art would typically require three or four people to assemble and suspend the same number of line array speakers, taking substantially more time, typically up to two hours.

With regard to material, the array frame may be made of 6061 T-6 aluminum and includes a plurality of holes (not shown) for fitting shackles for suspending in the air. Alternatively, the rigging frames 110 may be made of heat-treated 4130 premium steel alloy and may be attached to the speaker 102 with machine screws set into four pads on each end of the speaker.

While various embodiments of the application have been described, it will be apparent to those of ordinary skill in the art that many more embodiments and implementations are possible within the scope of this invention. Accordingly, the invention is not to be restricted except in light of the attached claims and their equivalents.

What is claimed is:

1. A rigging system for coupling a plurality of line array speakers, comprising:
a left side frame and a right side frame adapted to couple to a left side and a right side of a line array speaker respectively, the left and right side frames each having a front side that is longer than a rear side;
a front left hinge slidably disposed in the front side of the left side frame and adapted to pivotally couple to a front side of an adjacent left side frame;
a front right hinge slidably disposed in the front side of the right side frame and adapted to pivotally couple to a front side of an adjacent right side frame;
a back left hinge slidably disposed in the rear side of the left side frame and adapted to adjustably couple to a rear side of an adjacent left side frame, wherein the back left hinge adjustably couples to the adjacent rear side of the left side frames to provide a predetermined distance therebetween; and
a back right hinge slidably disposed in the rear side of the right side frame and adapted to adjustably couple to a rear side of an adjacent right side frame, wherein the back right hinge adjustably couples the adjacent rear side of the right side frames to provide a predetermined distance therebetween.
